(19) United States
(12) Patent Application Publication
(10) Pub. No.: US 2026/0036800 A1
(43) Pub. Date: Feb. 5, 2026

(54) OBJECTIVE

(71) Applicant: Evident Corporation, Tatsuno-machi, Kamiina-gun, Nagano (JP)

(72) Inventor: Kenichiro ABE, Kamiina-gun (JP)

(73) Assignee: Evident Corporation, Tatsuno-machi, Kamiina-gun, Nagano (JP)

(21) Appl. No.: 19/278,553

(22) Filed: Jul. 23, 2025

(30) Foreign Application Priority Data
Jul. 31, 2024 (JP) 2024-124586

(51) Int. Cl. G02B 21/02; G02B 9/34

(52) U.S. Cl. CPC G02B 21/02; G02B 9/34

(57) ABSTRACT

An objective includes a first lens group, a second lens group configured to move along an optical axis, a third lens group having two or more cemented surfaces, and a fourth lens group including a lens having a convex surface directed to the object side, a lens having a concave surface on an image side, a lens having a concave surface on the object side, and a lens having a convex surface on the image side. The first lens group has three or more lens components including a lens component in which a positive lens having a convex surface on the image side and a meniscus lens having a concave surface on the object side are cemented on outermost object side, and none of the three or more lens components is a cemented lens in which a negative lens is disposed closer to the object side than a positive lens.

### CROSS-REFERENCE TO RELATED APPLICATION

This application is based upon and claims the benefit of priority from prior Japanese Patent Application No. 2024-124586, filed Jul. 31, 2024, the entire contents of which are incorporated herein by this reference.

### FIELD OF DISCLOSURE

The disclosure of the present specification relates to an objective.

### BACKGROUND

In recent years, there has been a significant increase in the number of pixels of imaging elements, which is remarkable, and in the field of microscopes, there is demand for a microscope device capable of performing observation and image acquisition that achieve both a wide field of view and a high resolution, and an objective having a high number of apertures (hereinafter, referred to as NA) is desired.

In an objective having a high NA, the spherical aberration significantly varies with respect to change in the thickness of a cover glass, the refractive index of a specimen, and the refractive index of an immersion liquid. Therefore, in order to correct the variation of the spherical aberration, it is desirable to have a mechanism that moves a lens component in the objective along an optical axis. Such an objective is disclosed in, for example, JP 2004-029067 A.

### SUMMARY

According to an aspect of the present invention, an objective includes, in order from an object side, a first lens group having positive refractive power, a second lens group having positive refractive power and configured to move along an optical axis, a third lens group having two or more cemented surfaces, and a fourth lens group including, in order from the object side, a lens having a convex surface directed to the object side, a lens having a concave surface directed to an image side, a lens having a concave surface directed to the object side, and a lens having a convex surface directed to the image side. The first lens group has at least three or more lens components including a first lens component in which a positive lens having a convex surface directed to the image side and a meniscus lens having a concave surface directed to the object side are cemented, on an outermost object side, and none of the at least three or more lens components is a cemented lens in which a negative lens is disposed closer to the object side than a positive lens.

### BRIEF DESCRIPTION OF THE DRAWINGS

FIG. 1 is a cross-sectional view of an objective according to a first example of the present invention;

FIG. 2 is a cross-sectional view of an imaging lens;

FIGS. 3A to 3D are aberration diagrams of an optical system including the objective and the imaging lens in a first state according to the first example;

FIGS. 4A to 4D are aberration diagrams of the optical system including the objective and the imaging lens in a second state according to the first example;

FIGS. 5A to 5D are aberration diagrams of the optical system including the objective and the imaging lens in a third state according to the first example;

FIG. 6 is a cross-sectional view of an objective according to a second example of the present invention;

FIGS. 7A to 7D are aberration diagrams of an optical system including the objective and an imaging lens in the first state according to a second example;

FIGS. 8A to 8D are aberration diagrams of the optical system including the objective and the imaging lens in the second state according to a second example;

FIGS. 9A to 9D are aberration diagrams of the optical system including the objective and the imaging lens in the third state according to a second example;

FIG. 10 is a cross-sectional view of an objective according to a third example of the present invention;

FIGS. 11A to 11D are aberration diagrams of an optical system including the objective and an imaging lens in the first state according to a third example;

FIGS. 12A to 12D are aberration diagrams of the optical system including the objective and the imaging lens in the second state according to a third example;

FIGS. 13A to 13D are aberration diagrams of the optical system including the objective and the imaging lens in the third state according to a third example;

FIG. 14 is a cross-sectional view of an objective according to a fourth example of the present invention;

FIGS. 15A to 15D are aberration diagrams of an optical system including the objective and an imaging lens in the first state according to a fourth example;

FIGS. 16A to 16D are aberration diagrams of the optical system including the objective and the imaging lens in the second state according to a fourth example; and

FIGS. 17A to 17D are aberration diagrams of the optical system including the objective and the imaging lens in the third state according to a fourth example.

### DETAILED DESCRIPTION

In the conventional objective, aberrations other than spherical aberration such as axial chromatic aberration and coma aberration greatly change with respect to movement of a lens component. Therefore, it is difficult to realize high performance in a wide wavelength range and a wide visual field range.

An objective according to an embodiment of the present application will be described. The objective according to the present embodiment (simply referred to as an objective below) is an infinity-corrected microscope objective used in combination with an imaging lens. In the present specification, the lens component refers to a single lens block in which only two surfaces that are a surface on an object side and a surface on an image side among lens surfaces through which a light ray from an object point passes have contact with air regardless of whether the lens is a single lens or a cemented lens. In other words, one single lens is one lens component, and one cemented lens is also one lens component. On the other hand, a plurality of single lenses and a plurality of cemented lenses arranged with air therebetween are not referred to as one lens component herein.

The objective includes a first lens group having positive refractive power, a second lens group having positive refractive power, a third lens group, and a fourth lens group, which are disposed in order from an object side. The second lens group is a moving group that moves along the optical axis. The third lens group has two or more cemented surfaces. The fourth lens group includes a lens having a convex surface directed to the object side, a lens having a concave surface directed to the image side, a lens having a concave surface directed to the object side, and a lens having a convex surface directed to the image side, in order from the object side.

In the objective configured as described above, by disposing the second lens group that is a moving group having positive refractive power, at a stage subsequent to the first lens group having positive refractive power, light enters the second lens group in a state where the divergence of the light from an object point is sufficiently reduced. Therefore, it is possible to prevent an occurrence of a situation in which the occurrence amount (correction amount) of spherical aberration in the second lens group becomes excessively large. Furthermore, since the height of the marginal light ray passing through the first lens group can be caused to greatly vary by the movement of the second lens group, it is possible to sufficiently change the occurrence amount of spherical aberration occurring in the first lens group. Therefore, it is possible to favorably correct the spherical aberration caused by the change in the thickness of a cover glass or the like, by the movement of the second lens group.

Since the third lens group has two or more cemented surfaces, the third lens group through which a light ray having a high marginal ray height passes can favorably correct axial chromatic aberration. Further, by imparting a large axial chromatic aberration correction action to the third lens group, it is possible to relatively reduce the axial chromatic aberration correction action required for the first lens group and the second lens group. By imparting a relatively small axial chromatic aberration correction action to the first lens group and the second lens group that are located closer to the object side than the third lens group and in which the marginal light ray height greatly varies by the movement of the second lens group, the variation of the axial chromatic aberration can be suppressed to be small even though the spherical aberration is corrected by moving the second lens group with respect to the change in the thickness of the cover glass or the like, and as a result, it is possible to stably perform favorable chromatic aberration correction.

The two or more cemented surfaces of the third lens group may be, for example, two cemented surfaces included in two two-cemented lenses, that is, may be included in two or more cemented lenses. The two or more cemented surfaces of the third lens group may be, for example, two cemented surfaces included in one three-cemented lens, that is, may be included in one cemented lens.

The third lens group refers to up to lens components including the second cemented surface counted from a lens component close to the second lens group (object side) among lens components located closer to the image side than the second lens group that are the moving group. Therefore, for example, in the case of an objective including three two-cemented lenses closer to the image side than the second lens group, the third lens group refers to lens components up to the second two-cemented lens closer to the image side than the second lens group among lens components closer to the image side than the second lens group, and the subsequent lens components constitute the fourth lens group. For example, in the case of an objective including a three-cemented lens immediately adjacent to the second lens group on the image side, the third lens group includes only the three-cemented lens, and the subsequent lens components constitute the fourth lens group.

The fourth lens group includes an optical system called a so-called Gauss group having a pair of concave surfaces facing each other and a pair of convex surfaces that are disposed outside the pair of concave surfaces and directed outward. As a result, it is possible to lower the marginal light ray height in the pair of concave surfaces facing each other, and thus it is possible to effectively correct the Petzval sum and to sufficiently reduce the field curvature.

In the objective described above, the first lens group has at least three or more lens components. This configuration enables the first lens group to gently converge light diverging from an object point. As a result, it is possible to mainly reduce the occurrence of spherical aberration and coma aberration.

In the above-described objective, the first lens group includes a first lens component in which a positive lens having a convex surface directed to the image side and a meniscus lens having a concave surface directed to the object side are cemented, on the outermost object side. This configuration makes it possible to favorably correct the field curvature. More specifically, by imparting a refraction action by the concave surface of the meniscus lens at the cemented surface of the first lens component on which light emitted from the object point and is incident before the marginal light ray height increases, it is possible to effectively correct the Petzval sum.

Furthermore, since the lens cemented to the concave surface of the meniscus lens on the object side is a positive lens, a first surface (lens surface on the outermost object side) of the objective does not become a strong concave surface. Therefore, when the objective is immersed in the immersion liquid, air bubbles can be made less likely to enter between the objective and the immersion liquid. This makes it possible to avoid the occurrence of aberration caused by air bubbles.

In the above-described objective, at least three or more lens components that include the first lens component and are included in the first lens group have common characteristics that none of these lens components is a cemented lens in which a negative lens is disposed closer to the object side than a positive lens. This configuration makes it possible to favorably correct the axial chromatic aberration and spherical aberration between different wavelengths. More specifically, when the first lens group includes the cemented lens in which the negative lens is disposed on the object side, divergent light is incident on the cemented surface that has an achromatization action and is located on the image side of the negative lens, and the incident angle of the marginal light ray with respect to the cemented surface increases. Since the refraction angle is proportional to the sine of the incident angle, the larger the incident angle, the larger the refraction angle. As a result, a difference in the angle of refraction occurring between the wavelengths also increases. That is, the existence of the cemented lens in which the negative lens is disposed on the object side in the first lens group causes a large refractive angle difference between wavelengths. When the marginal light ray height in the first lens group changes by the movement of the second lens group in a state where such a cemented lens is in the first lens group, a large difference in refraction angle between different wavelengths on the cemented surface greatly varies, so that it becomes difficult to favorably correct axial chromatic aberration and spherical aberration between different wavelengths. On the other hand, in the objective described above, since the first lens group does not include a cemented lens in which the negative lens is disposed closer to the object side than the positive lens, such a difficulty does not occur, and it is possible to favorably correct the axial chromatic aberration and the spherical aberration between different wavelengths. For the similar reason, in a case where the first lens group includes a cemented lens other than the first lens component, it is desirable that the cemented surface also has a concave surface directed to the object side.

According to the objective configured as described above, it is possible to favorably correct chromatic aberration and off-axis performance while achieving a high NA. More specifically, in the objective having a high NA, even in a case where the correction amount of the spherical aberration is adjusted by moving the second lens group that is the moving group, it is possible to stably and favorably correct the chromatic aberration and the off-axis performance. A desirable configuration of the objective will be described below.

The third lens group desirably includes two cemented lenses. Since the third lens group includes two cemented lenses, the third lens group has two or more cemented surfaces and two or more sets of air interfaces. This makes it possible to make a difference in the refraction angle and the light ray height of the marginal light ray in each refraction surface (lens surface). As a result, it is possible to impart an action of mainly correcting coma aberration in addition to axial chromatic aberration to the third lens group, and it is possible to more favorably correct aberration performance in the periphery (off-axis).

Each of the two cemented lens components included in the third lens group desirably has a cemented surface with a concave surface directed to the image side. In order to reduce the difference in coma aberration occurring between wavelengths, it is desirable that the cemented lens component is a lens component in which a negative lens on the object side and a positive lens on the image side are cemented, in other words, it is desirable to have a cemented surface with a concave surface directed to the image side. The divergence of light is reduced in the first lens group and the second lens group, and the light enters and passes through the third lens group while converging. Therefore, since the concave surface in the cemented surface inside the third lens group is directed to the image side, the refraction angle of the off-axis marginal light ray on the cemented surface does not become too large, and the occurrence of coma aberration on the cemented surface can be suppressed to be small. As a result, it is possible to further reduce the difference in coma aberration occurring between wavelengths called color frames.

The fourth lens group desirably includes three or more lens components. Since the fourth lens group includes three or more lens components, it is possible to simultaneously correct the chromatic aberration of magnification and the difference in astigmatism and the difference in coma between wavelengths. This will be described in more detail below. In the fourth lens group disposed closest to the image side, it is preferable to dispose a lens pair having different dispersion characteristics in order to correct the chromatic aberration of magnification. However, when the lens pair is cemented, coma aberration and astigmatism occurring on the cemented surface are different between wavelengths, and a difference occurs therebetween. Therefore, the fourth lens group is configured to include three or more lens components. As a result, since four or more air interfaces can be provided in addition to the facing concave surfaces having the above-described Petzval sum correction action, it is possible to favorably correct astigmatism and coma aberration by differentiating the refraction angle and the light ray height of the off-axis ray at the air interfaces. As a result, chromatic aberration of magnification, astigmatism, and coma aberration can be corrected more favorably in a wide wavelength range.

The second lens group desirably consists of one lens component having a meniscus shape with a concave surface directed to the object side. Since the lens component moving in the optical axis direction has a meniscus shape with a concave surface directed to the object side, it is possible to suppress the occurrence of coma aberration to be small. Therefore, it is also possible to suppress the variation in coma aberration due to the movement of the lens component to be small.

The second lens group desirably consists of a single lens. Since the lens component moving in the optical axis direction consists of a single lens having no large chromatic aberration correction action, it is possible to suppress the variation of the axial chromatic aberration due to the movement of the lens component to be small.

It is desirable that the first lens group has, on the image side with respect to the first lens component, a cemented lens component obtained by cementing a positive lens and a negative lens disposed in order from the object side. Since the first lens group located closest to the object side further includes the cemented lens in addition to the first lens component, it is possible to favorably correct the chromatic aberration of magnification. However, when the cemented lens in which the negative lens is disposed on the object side is disposed in the first lens group as described above, the axial chromatic aberration and the variation of the spherical aberration between different wavelengths are increased by the movement of the second lens group, which is not preferable. Therefore, the first lens group includes, in addition to the first lens component, a cemented lens component in which a positive lens and a negative lens are cemented from the object side. As a result, the chromatic aberration of magnification can favorably be corrected while the axial chromatic aberration and the variation of the spherical aberration between the different wavelengths are suppressed by the movement of the second lens group. The cemented lens component different from the first lens component is more preferably a cemented lens component in which the cemented surface directs the concave surface toward the object side for the reason described above.

It is desirable that the objective is configured to satisfy at least one of following conditional expressions (1) and (2).

$$0.25 ≦ \vert {d}_{1 GR} / TTL \vert ≦ 0.5 \qquad ( 1 )$$

$$0.3 ≦ \vert {d}_{3 G F} / {d}_{F B} \vert ≦ 1 \qquad ( 2 )$$

d_{1GR} is a distance on the optical axis from an object plane to a lens surface of the first lens group closest to image side. TTL is a distance on the optical axis from the object plane to the lens surface of the objective on the side closest to the image side. d_{3GF} is a distance on the optical axis from the object plane to the lens surface of the third lens group on the side closest to the object side. d_{FB} is a distance on the optical axis from the object plane to the rear focal position of the objective. The object plane is a surface including a condensing position when a collimated light flux is incident on the objective from the image side, that is, a front focal position. More specifically, the object plane is a surface including the front focal position of the objective in a case where the position of the second lens group is adjusted to favorably correct the spherical aberration in the standard state (specifically, the cover glass has a thickness of 0.17 mm).

The conditional expression (1) defines a space given to the first lens group. It is desirable to satisfy the conditional expression (1) in order to simultaneously and favorably correct mainly spherical aberration and coma aberration. Since |d_{1GR}/TTL| does not fall below the lower limit value, the first lens group having a function of gradually reducing the divergence of the light emitted from the object can have a sufficient space. Therefore, it is possible to reduce the divergence of the incident light while suppressing the occurrence of spherical aberration. Since |d_{1GR}/TTL| does not exceed the upper limit value, it is possible to sufficiently secure a space after the third lens group while sufficiently securing a space where the second lens group moves. Therefore, the off-axis light flux can be gently converged in the third lens group, and the occurrence of coma aberration in the third lens group can be suppressed to be small.

The conditional expression (2) defines the positional relationship between the exit pupil position and the second lens group. It is desirable to satisfy the conditional expression (2) in order to suppress the variation of the coma aberration mainly due to the movement of the second lens group. In a case where the objective is configured as an object-side telecentric optical system, the rear focal position is the exit pupil position, and coma aberration occurs more greatly on the image side than the exit pupil position. Since |d_{3GH}/d_{FB}| does not exceed the upper limit value, the second lens group is sufficiently disposed on the object side with respect to the exit pupil position, and as a result, the occurrence of coma aberration in the second lens group can be suppressed to be small. Therefore, the variation in coma aberration due to the movement of the second lens group can also be suppressed to be small. Since |d_{3GF}/d_{FB}| does not fall below the lower limit value, the first lens group can have a sufficient space while sufficiently securing a space where the second lens group moves. Therefore, it is possible to reduce the divergence of the incident light while suppressing the occurrence of spherical aberration.

Hereinafter, examples of the objective described above will be described in detail.

### First Example

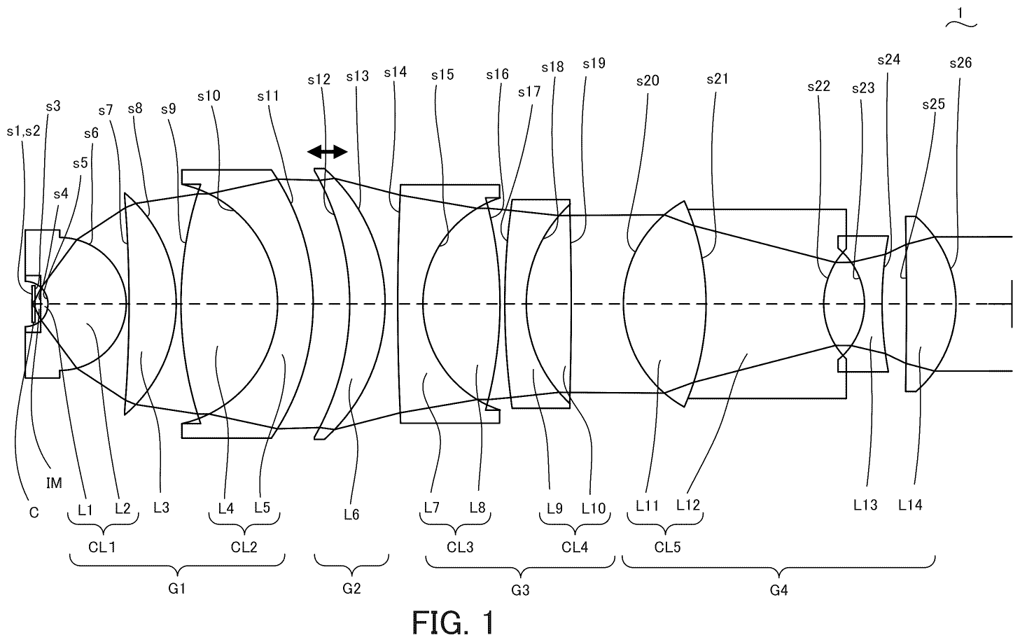

FIG. 1 is a cross-sectional view of an objective 1 according to the present example. The objective 1 is a liquid immersion objective for microscope. The objective 1 includes, in order from the object side, a first lens group G1 having positive refractive power, a second lens group G2 having positive refractive power, and a third lens group G3, and a fourth lens group G4.

The first lens group G1 includes, in order from the object side, a cemented lens CL1, a lens L3 that is a meniscus lens having a concave surface directed to the object side, and a cemented lens CL2. The cemented lens CL1 is a two-lens cemented lens in which a lens L1 that is a positive lens having a convex surface directed to the image side and a lens L2 that is a meniscus lens having a concave surface directed to the object side are cemented, and is a first lens component. The cemented lens CL2 is a two-lens cemented lens in which a lens L4 that is a biconvex lens and a lens L5 that is a meniscus lens having a concave surface directed to the object side are cemented. Both the cemented lens CL1 and the cemented lens CL2 are not cemented lenses in which the negative lens is disposed closer to the object side than the positive lens.

The second lens group G2 includes a lens L6 that moves along the optical axis. The lens L6 includes one lens component having a meniscus shape with a concave surface directed to the object side, and is a single lens.

The third lens group G3 includes, in order from the object side, a cemented lens CL3 and a cemented lens CL4. The cemented lens CL3 is a two-lens cemented lens in which a lens L7 that is a meniscus lens having a concave surface directed to the image side and a lens L8 that is a biconvex lens are cemented. The cemented lens CL4 is a two-lens cemented lens in which a lens L9 that is a meniscus lens having a concave surface directed to the image side and a lens L10 that is a biconvex lens are cemented. Each of the cemented lens CL3 and the cemented lens CL4 has a cemented surface with a concave surface directed to the image side.

The fourth lens group G4 includes, in order from the object side, a cemented lens CL5, a lens L13 that is a biconcave lens, and a lens L14 that is a meniscus lens having a concave surface directed to the object side. The cemented lens CL5 is a two-lens cemented lens in which a lens L11 that is a biconvex lens and a lens L12 that is a biconcave lens are cemented.

Various types of data of the objective 1 are as follows. The NA is the number of apertures of the objective 1 on the object side. f, f_{G1}, f_{G2}, f_{G3}, and f_{G4} are the focal length of the objective 1, the focal length of the first lens group G1, the focal length of the second lens group G2, the focal length of the third lens group G3, and the focal length of the fourth lens group G4, respectively. The reference wavelength is the d-line.

NA=1.2,f=3.001 mm,f_{G1}=4.499 mm,f_{G2}=60.488 mm,f_{G3}=−48.804 mm,f_{G4}=−139.527 mm,TTL=49.537 mm,d_{1GR}=15.074 mm,d_{3GF}=19.609 mm,d_{FB}=21.766 mm

Lens data of the objective 1 is as follows. INF in the lens data indicates infinity (∞).

Objective Lens 1

| s | r | d | nd | νd |
|---|---|---|---|---|
| 1 | INF | 0 | 1.33304 | 55.79 |
| 2 | INF | t | 1.52397 | 54.41 |
| 3 | INF | D0 | 1.33304 | 55.79 |
| 4 | INF | 0.395 | 1.45858 | 67.84 |
| 5 | −1.2180 | 4.192 | 1.80400 | 46.53 |
| 6 | −3.5667 | 0.150 | | |
| 7 | −71.0697 | 2.533 | 1.56907 | 71.30 |
| 8 | −7.8008 | 0.250 | | |
| 9 | 20.0965 | 5.182 | 1.43875 | 94.66 |
| 10 | −6.5846 | 1.904 | 1.63775 | 42.41 |
| 11 | −12.6961 | D1 | | |
| 12 | −14.4620 | 1.900 | 1.43875 | 94.66 |
| 13 | −9.7360 | D2 | | |
| 14 | 131.1700 | 1.350 | 1.63775 | 42.41 |
| 15 | 5.9861 | 4.131 | 1.43875 | 94.66 |
| 16 | −21.5087 | 0.260 | | |
| 17 | 40.1015 | 1.150 | 1.67790 | 55.35 |
| 18 | 7.2757 | 2.410 | 1.43875 | 94.66 |
| 19 | −177.6884 | 2.794 | | |
| 20 | 6.3135 | 4.437 | 1.56907 | 71.30 |
| 21 | −13.6241 | 6.304 | 1.80400 | 46.53 |
| 22 | 4.2213 | 2.185 | | |
| 23 | −3.8809 | 0.941 | 1.51823 | 58.90 |
| 24 | 19.5035 | 1.312 | | |
| 25 | −192.6448 | 2.655 | 1.67300 | 38.26 |
| 26 | −6.2054 | 110.000 | | |

Here, s indicates a surface number, r indicates a radius of curvature (mm), d indicates a surface spacing (mm), nd indicates a refractive index, and vd indicates an Abbe number. The reference wavelength is the d-line (587.56 nm). These symbols are similar in the following examples. Both surfaces indicated by surface numbers s1 and s2 are object-side surfaces of a cover glass CG and a surface indicated by a surface number s3 is an image-side surface of the cover glass CG. Surfaces indicated by surface numbers s4 and s26 are a lens surface of the objective 1 that is closest to the object side and a lens surface of the objective 1 that is closest to the image side, respectively. For example, the surface spacing d1 indicates a distance on the optical axis from the surface indicated by the surface number s1 to the surface indicated by the surface number s2. The surface spacing d26 indicates a distance on the optical axis from the surface indicated by the surface number s26 to the imaging lens, and is 110 mm.

When a state in which the second lens group is moved in accordance with the cover glass CG having a thickness of 0.17 mm is referred to as a first state (standard state), a state in which the second lens group is moved in accordance with the cover glass CG having a thickness of 0.11 mm is referred to as a second state, and a state in which the second lens group is moved in accordance with the cover glass CG having a thickness of 0.23 mm is referred to as a third state, D0, D1, and D2 which are values (unit: mm) of intervals d3, d11, and d13 in the lens data in each state are as follows.

First State, Second State, and Third State

| | | | |
|---|---|---|---|
| t | 0.17 | 0.11 | 0.23 |
| D0 | 0.298 | 0.335 | 0.261 |
| D1 | 1.961 | 2.108 | 1.808 |
| D2 | 0.674 | 0.527 | 0.827 |

The objective 1 satisfies conditional expressions (1) and (2) as indicated below.

$$\vert {d}_{1 GR} / TTL \vert = 0.3 \qquad ( 1 )$$

$$\vert {d}_{3 G F} / {d}_{F B} \vert = 0.9 \qquad ( 2 )$$

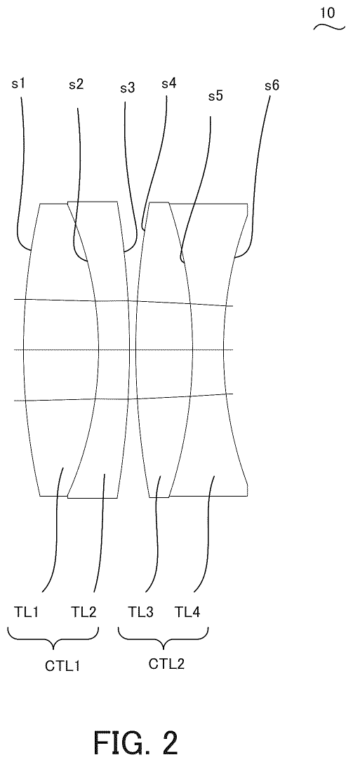

FIG. 2 is a cross-sectional view of an imaging lens 10 used in combination with the objective 1. The imaging lens 10 is a microscope imaging lens that forms an enlarged image of an object in combination with the infinity-corrected objective. The imaging lens 10 includes, in order from the object side, a cemented lens CTL1 and a cemented lens CTL2. The cemented lens CTL1 is a two-lens cemented lens including a lens TL1 that is a biconvex lens and a lens TL2 that is a meniscus lens having a concave surface directed to the object side. The cemented lens CTL2 is a two-lens cemented lens including a lens TL3 that is a biconvex lens and a lens TL4 that is a biconcave lens. The focal length ft of the imaging lens 10 is 180 mm.

Lens data of the imaging lens 10 is as follows.

Imaging Lens 10

| s | r | d | nd | νd |
|---|---|---|---|---|
| 1 | 68.7541 | 7.7321 | 1.48749 | 70.21 |
| 2 | −37.5679 | 3.4742 | 1.80610 | 40.95 |
| 3 | −102.8477 | 0.6973 | | |
| 4 | 84.3099 | 6.024 | 1.83400 | 37.17 |
| 5 | −50.7100 | 3.030 | 1.64450 | 40.82 |
| 6 | 40.6619 | 9.038 | | |

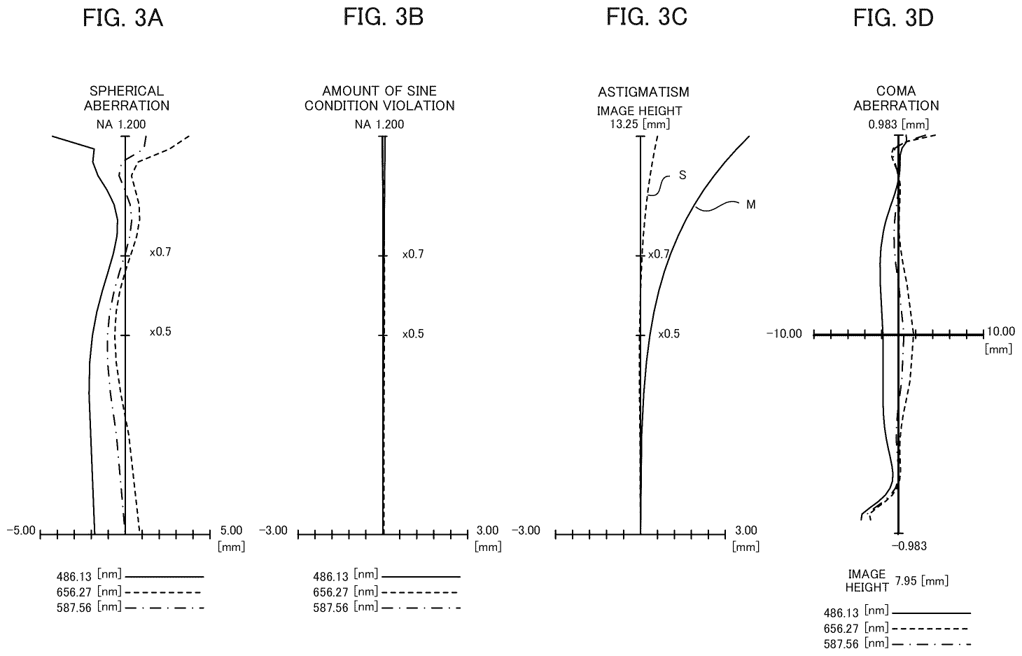

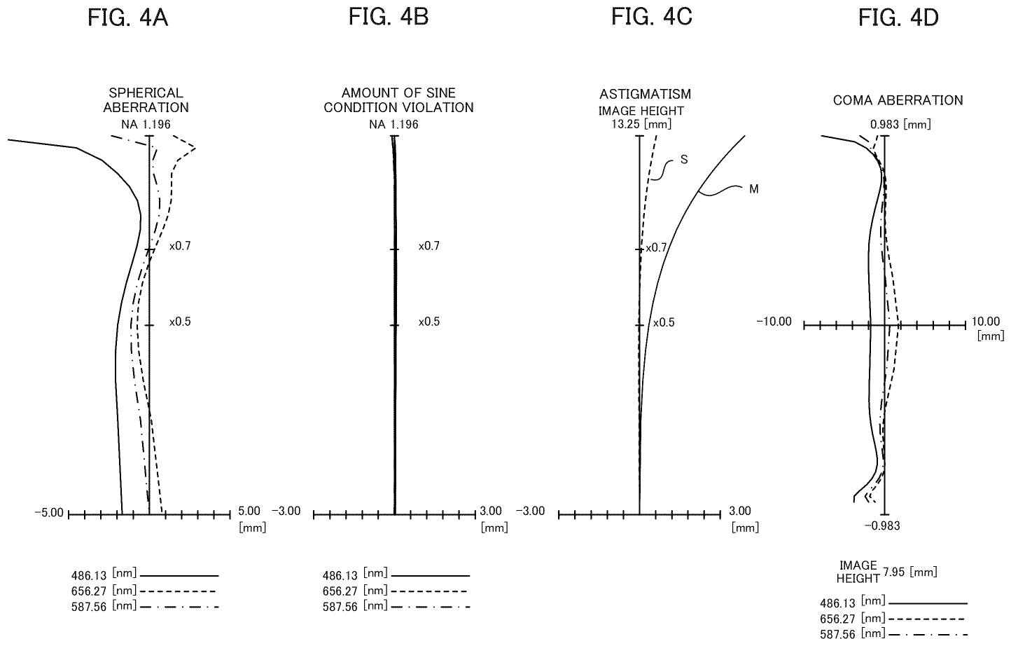

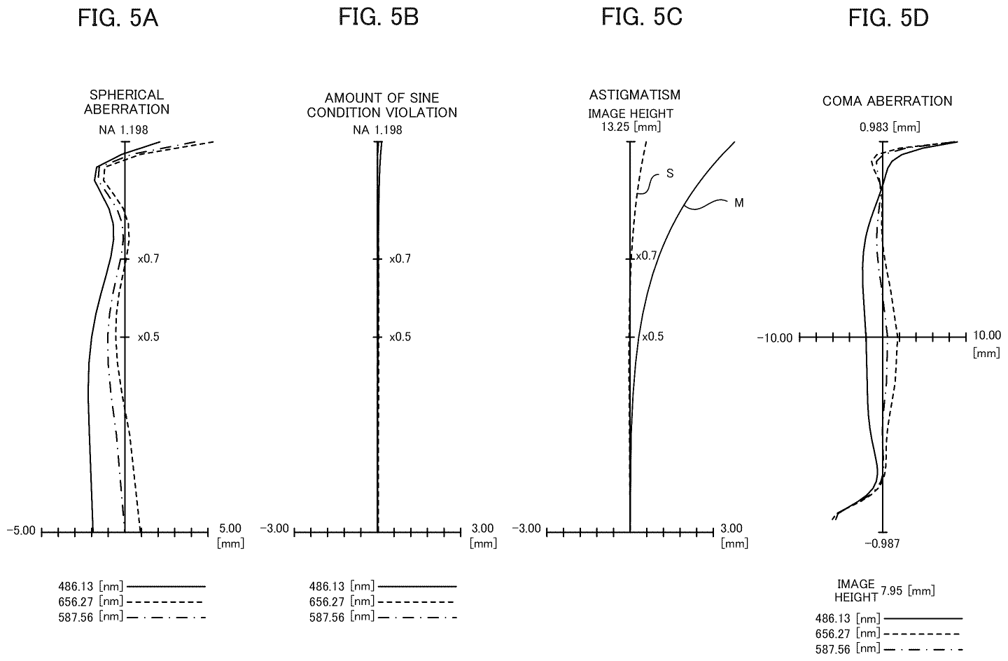

FIGS. 3A to 5D are aberration diagrams of the optical system including the objective 1 and the imaging lens 10, and illustrate aberrations on an image plane on which the objective 1 and the imaging lens 10 are formed, in the first state, the second state, and the third state, respectively. FIGS. 3A, 4A, and 5A are diagrams of spherical aberrations. FIGS. 3B, 4B, and 5B are diagrams illustrating the amounts of sine condition violation. FIGS. 3C, 4C, and 5C are astigmatism diagrams. FIGS. 3D, 4D, and 5D are diagrams illustrating coma aberrations at an image height ratio of 0.6 (image height of 7.95 mm). In the drawings, “M” indicates a meridional component, and “S” indicates a sagittal component. As illustrated in FIGS. 3A to 5D, in the present example, the aberration is favorably corrected regardless of the thickness of the cover glass.

### Second Example

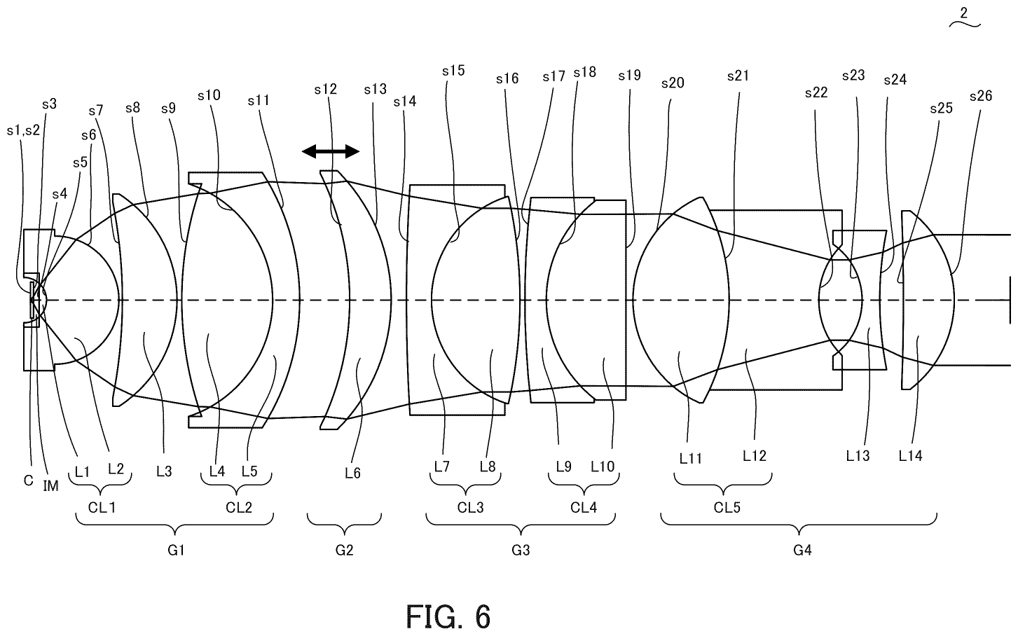

FIG. 6 is a cross-sectional view of an objective 2 according to the present example. The objective 2 is a liquid immersion objective for microscope. The objective 2 includes, in order from the object side, a first lens group G1 having positive refractive power, a second lens group G2 having positive refractive power, and a third lens group G3, and a fourth lens group G4.

The first lens group G1 includes, in order from the object side, a cemented lens CL1, a lens L3 that is a meniscus lens having a concave surface directed to the object side, and a cemented lens CL2. The cemented lens CL1 is a two-lens cemented lens in which a lens L1 that is a positive lens having a convex surface directed to the image side and a lens L2 that is a meniscus lens having a concave surface directed to the object side are cemented, and is a first lens component. The cemented lens CL2 is a two-lens cemented lens in which a lens LA that is a biconvex lens and a lens L5 that is a meniscus lens having a concave surface directed to the object side are cemented. Both the cemented lens CL1 and the cemented lens CL2 are not cemented lenses in which the negative lens is disposed closer to the object side than the positive lens.

The second lens group G2 includes a lens L6 that moves along the optical axis. The lens L6 includes one lens component having a meniscus shape with a concave surface directed to the object side, and is a single lens.

The third lens group G3 includes, in order from the object side, a cemented lens CL3 and a cemented lens CLA. The cemented lens CL3 is a two-lens cemented lens in which a lens L7 that is a meniscus lens having a concave surface directed to the image side and a lens L8 that is a biconvex lens are cemented. The cemented lens CLA is a two-lens cemented lens in which a lens L9 that is a meniscus lens having a concave surface directed to the image side and a lens L10 that is a flat convex lens having a flat surface directed to the image side are cemented. Each of the cemented lens CL3 and the cemented lens CL4 has a cemented surface with a concave surface directed to the image side.

The fourth lens group G4 includes, in order from the object side, a cemented lens CL5, a lens L13 that is a biconcave lens, and a lens L14 that is a meniscus lens having a concave surface directed to the object side. The cemented lens CL5 is a two-lens cemented lens in which a lens L11 that is a biconvex lens and a lens L12 that is a biconcave lens are cemented.

Various types of data of the objective 2 are as follows.
NA=1.17,f=3.001 mm,f_{G1}=4.503 mm,f_{G2}=54.399 mm,f_{G3}=−48.23 mm,f_{G4}=−126.867 mm, TTL=49.56 mm,d_{1GR}=14.443 mm,d_{3GF}=20.167 mm,d_{FB}=26.119 mm

Lens data of the objective 2 is as follows.

Objective Lens 2

| s | r | d | nd | νd |
|---|---|---|---|---|
| 1 | INF | 0 | 1.33304 | 55.79 |
| 2 | INF | t | 1.52397 | 54.41 |
| 3 | INF | D0 | 1.33304 | 55.79 |
| 4 | INF | 0.395 | 1.45858 | 67.84 |
| 5 | −1.2180 | 3.881 | 1.80400 | 46.53 |
| 6 | −3.4453 | 0.188 | | |
| 7 | −27.0426 | 2.932 | 1.56907 | 71.30 |
| 8 | −6.7830 | 0.250 | | |
| 9 | 18.7649 | 4.878 | 1.43875 | 94.66 |
| 10 | −6.5896 | 1.450 | 1.63775 | 42.41 |
| 11 | −12.6961 | D1 | | |
| 12 | −15.4644 | 2.227 | 1.43875 | 94.66 |
| 13 | −9.7962 | D2 | | |
| 14 | 98.6743 | 1.350 | 1.63775 | 42.41 |
| 15 | 5.8453 | 4.745 | 1.43875 | 94.66 |
| 16 | −25.4378 | 0.260 | | |
| 17 | 45.9780 | 1.150 | 1.75500 | 52.32 |
| 18 | 6.7232 | 4.268 | 1.56907 | 71.30 |
| 19 | INF | 0.381 | | |
| 20 | 6.0546 | 5.163 | 1.56907 | 71.30 |
| 21 | −11.5090 | 4.808 | 1.80400 | 46.53 |
| 22 | 4.1733 | 2.324 | | |
| 23 | −3.6776 | 0.944 | 1.51823 | 58.90 |
| 24 | 19.1150 | 1.270 | | |
| 25 | −115.0525 | 2.731 | 1.67300 | 38.26 |
| 26 | −6.0445 | 110.000 | | |

D0, D1, and D2, which are values (unit: mm) of the intervals d3, d11, and d13 in the lens data in each of the first state to the third state, are as follows.

First State, Second State, and Third State

| | | | |
|---|---|---|---|
| t | 0.17 | 0.11 | 0.23 |
| D0 | 0.300 | 0.337 | 0.263 |
| D1 | 2.682 | 2.830 | 2.530 |
| D2 | 0.816 | 0.668 | 0.968 |

The objective 2 satisfies conditional expressions (1) and (2) as indicated below.

$$\vert {d}_{1 GR} / TTL \vert = 0.29 \qquad ( 1 )$$

$$\vert {d}_{3 G F} / {d}_{F B} \vert = 0.77 \qquad ( 2 )$$

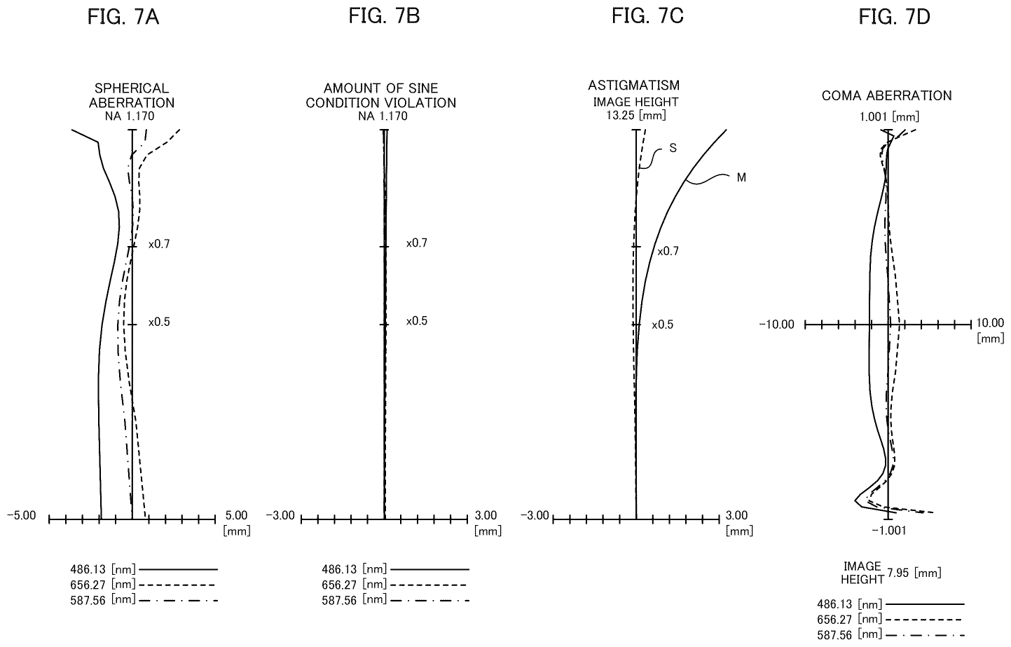

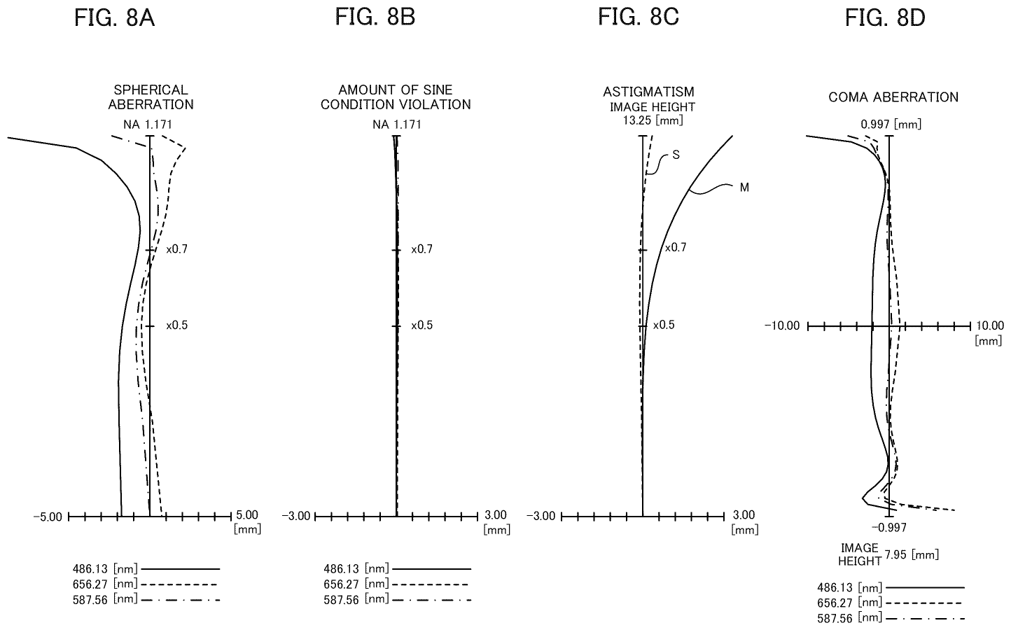

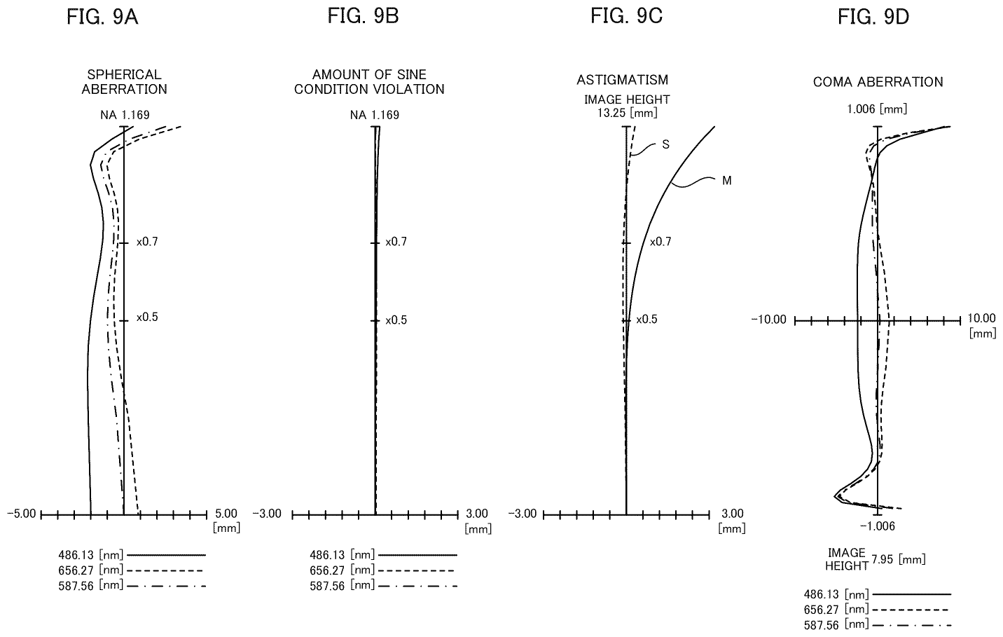

FIGS. 7A to 9D are aberration diagrams of the optical system including the objective 2 and the imaging lens 10, and illustrate aberrations on an image plane on which the objective 2 and the imaging lens 10 are formed, in the first state, the second state, and the third state, respectively. FIGS. 7A, 8A, and 9A are diagrams of spherical aberrations. FIGS. 7B, 8B, and 9B are diagrams illustrating the amounts of sine condition violation. FIGS. 7C, 8C, and 9C are astigmatism diagrams. FIGS. 7D, 8D, and 9D are diagrams illustrating coma aberrations at an image height ratio of 0.6 (image height of 7.95 mm). As illustrated in FIGS. 7A to 9D, in the present example, the aberration is favorably corrected regardless of the thickness of the cover glass.

### Third Example

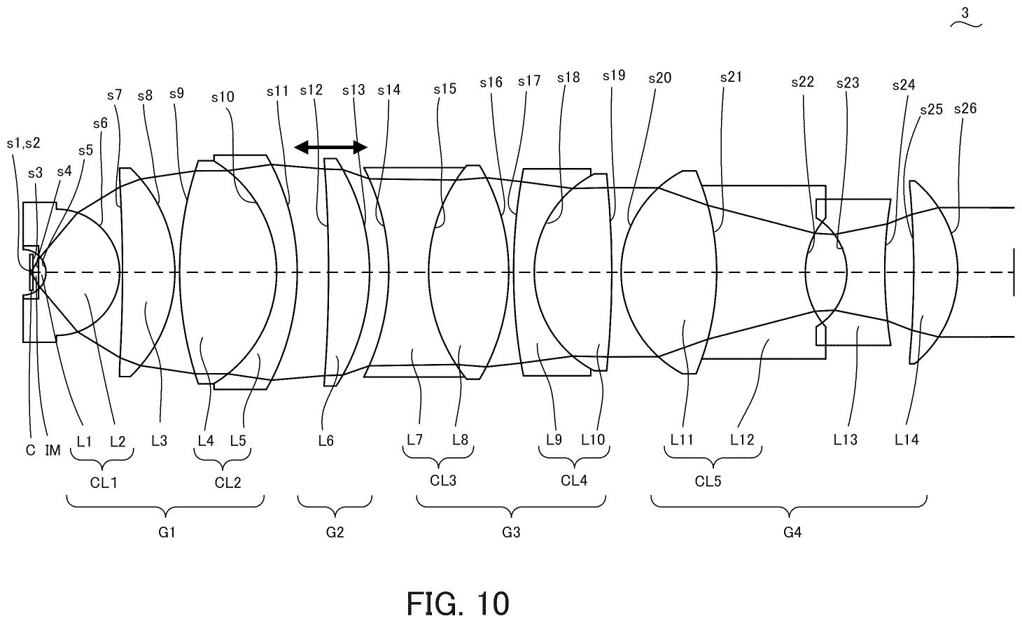

FIG. 10 is a cross-sectional view of an objective 3 according to the present example. The objective 3 is a liquid immersion objective for microscope. The objective 3 includes, in order from the object side, a first lens group G1 having positive refractive power, a second lens group G2 having positive refractive power, and a third lens group G3, and a fourth lens group G4.

The first lens group G1 includes, in order from the object side, a cemented lens CL1, a lens L3 that is a meniscus lens having a concave surface directed to the object side, and a cemented lens CL2. The cemented lens CL1 is a two-lens cemented lens in which a lens L1 that is a positive lens having a convex surface directed to the image side and a lens L2 that is a meniscus lens having a concave surface directed to the object side are cemented, and is a first lens component. The cemented lens CL2 is a two-lens cemented lens in which a lens L4 that is a biconvex lens and a lens L5 that is a meniscus lens having a concave surface directed to the object side are cemented. Both the cemented lens CL1 and the cemented lens CL2 are not cemented lenses in which the negative lens is disposed closer to the object side than the positive lens.

The second lens group G2 includes a lens L6 that moves along the optical axis. The lens L6 includes one lens component having a meniscus shape with a concave surface directed to the object side, and is a single lens.

The third lens group G3 includes, in order from the object side, a cemented lens CL3 and a cemented lens CL4. The cemented lens CL3 is a two-lens cemented lens in which a lens L7 that is a biconcave lens and a lens L8 that is a biconvex lens are cemented. The cemented lens CL4 is a two-lens cemented lens in which a lens L9 that is a meniscus lens having a concave surface directed to the image side and a lens L10 that is a biconvex lens are cemented. Each of the cemented lens CL3 and the cemented lens CL4 has a cemented surface with a concave surface directed to the image side.

The fourth lens group G4 includes, in order from the object side, a cemented lens CL5, a lens L13 that is a biconcave lens, and a lens L14 that is a meniscus lens having a concave surface directed to the object side. The cemented lens CL5 is a two-lens cemented lens in which a lens L11 that is a biconvex lens and a lens L12 that is a biconcave lens are cemented.

Various types of data of the objective 3 are as follows.

$$N A = 1.15 , f = 3.0 \; 02 mm , {f}_{G 1} = 4.2 \; 45 mm , {f}_{G 2} = 29. 8 \; 55 mm , {f}_{G 3} = - 28.8 \; 05 mm , {f}_{G 4} = - 104.167 mm , T T L = 49.5 \; 61 mm , {d}_{1 GR} = 14.2 \; 84 mm , {d}_{3 G F} = 19.1 \; 73 mm , {d}_{F B} = 19.6 \; 01 mm$$

Lens data of the objective 3 is described as follows.

Objective Lens 3

| s | r | d | nd | νd |
|---|---|---|---|---|
| 1 | INF | 0 | 1.33304 | 55.79 |
| 2 | INF | t | 1.52397 | 54.41 |
| 3 | INF | D0 | 1.33304 | 55.79 |
| 4 | INF | 0.395 | 1.45858 | 67.84 |
| 5 | −1.2180 | 3.935 | 1.80400 | 46.53 |
| 6 | −3.3786 | 0.150 | | |
| 7 | −85.1683 | 2.799 | 1.56907 | 71.30 |
| 8 | −7.7283 | 0.250 | | |
| 9 | 18.1315 | 5.186 | 1.43875 | 94.66 |
| 10 | −6.9596 | 1.100 | 1.63775 | 42.41 |
| 11 | −12.6961 | D1 | | |
| 12 | −75.7240 | 2.188 | 1.43875 | 94.66 |
| 13 | −11.2656 | D2 | | |
| 14 | −12.4588 | 2.127 | 1.63775 | 42.41 |
| 15 | 9.0479 | 4.278 | 1.43875 | 94.66 |
| 16 | −11.2853 | 0.260 | | |
| 17 | 29.7244 | 1.100 | 1.67790 | 55.35 |
| 18 | 5.9211 | 4.147 | 1.43875 | 94.66 |
| 19 | −50.2190 | 0.492 | | |
| 20 | 6.1176 | 5.107 | 1.56907 | 71.30 |
| 21 | −13.9035 | 4.733 | 1.80400 | 46.53 |
| 22 | 4.4559 | 2.222 | | |
| 23 | −3.4162 | 2.023 | 1.51823 | 58.90 |
| 24 | 23.6893 | 1.548 | | |
| 25 | −49.3212 | 2.351 | 1.67300 | 38.26 |
| 26 | −6.3462 | 110.000 | | |

D0, D1, and D2, which are values (unit: mm) of the intervals d3, d11, and d13 in the lens data in each of the first state to the third state, are as follows.

First State, Second State, and Third State

| | | | |
|---|---|---|---|
| t | 0.17 | 0.11 | 0.23 |
| D0 | 0.298 | 0.337 | 0.259 |
| D1 | 1.673 | 1.774 | 1.574 |
| D2 | 1.028 | 0.927 | 1.127 |

The objective 3 satisfies conditional expressions (1) and (2) as indicated below.

$$\vert {d}_{1 GR} / TTL \vert = 0.29 \qquad ( 1 )$$

$$\vert {d}_{3 G F} / {d}_{F B} \vert = 0.98 \qquad ( 2 )$$

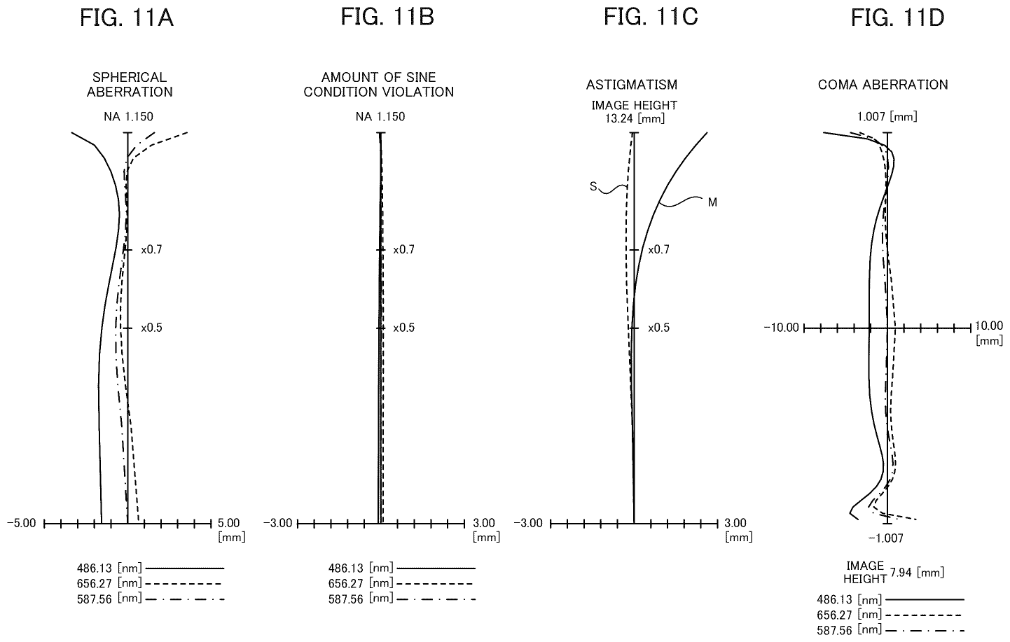

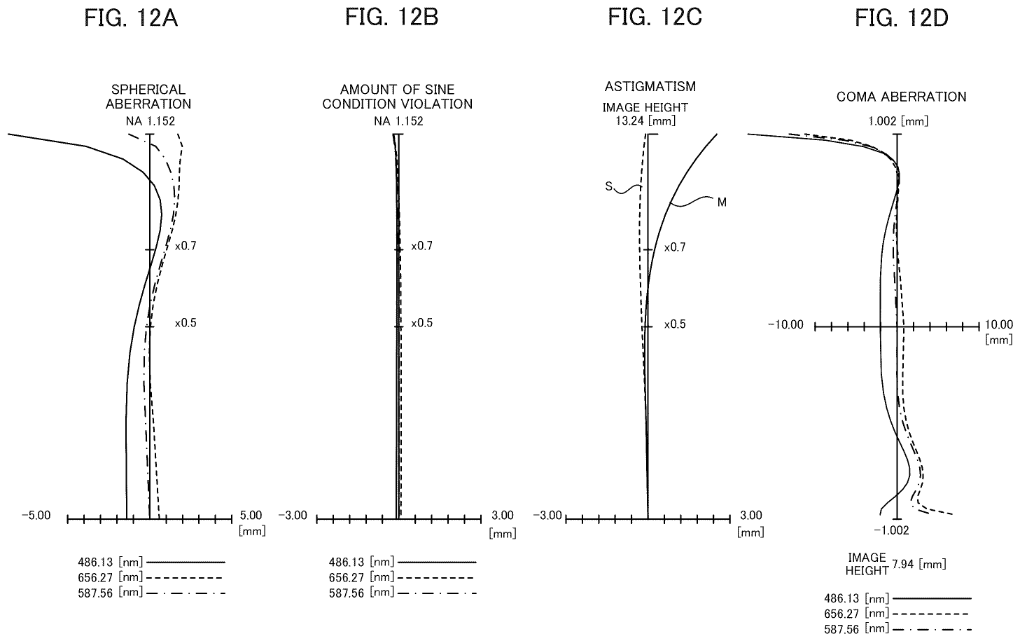

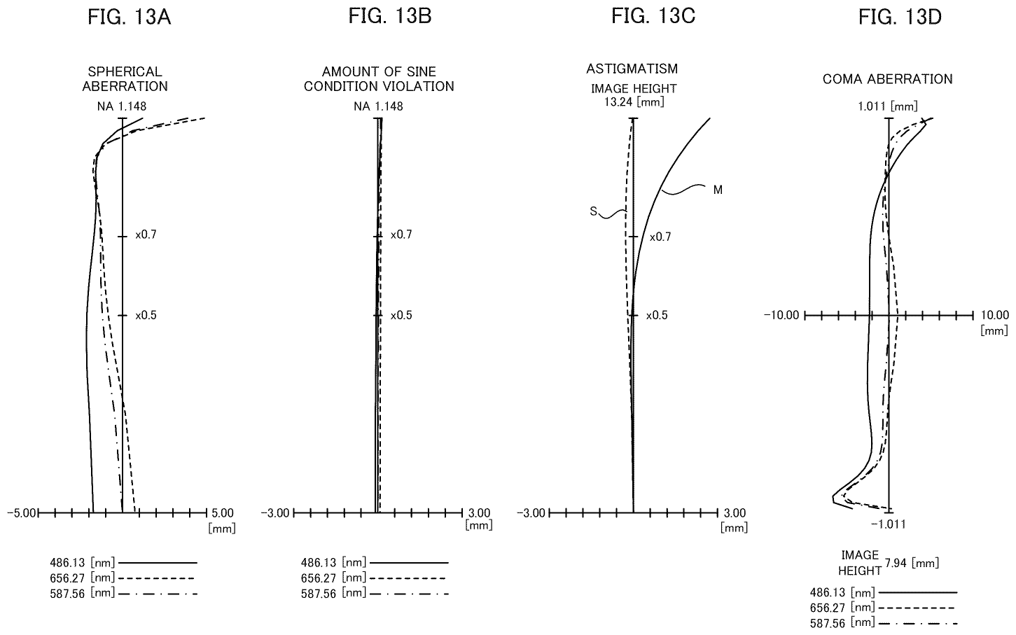

FIGS. 11A to 13D are aberration diagrams of the optical system including the objective 3 and the imaging lens 10, and illustrate aberrations on an image plane on which the objective 3 and the imaging lens 10 are formed, in the first state, the second state, and the third state, respectively. FIGS. 11A, 12A, and 13A are diagrams of spherical aberrations. FIGS. 11B, 12B, and 13B are diagrams illustrating the amounts of sine condition violation. FIGS. 11C, 12C, and 13C are astigmatism diagrams. FIGS. 11D, 12D, and 13D are diagrams illustrating coma aberrations at an image height ratio of 0.6 (image height of 7.95 mm). As illustrated in FIGS. 11A to 13D, in the present example, the aberration is favorably corrected regardless of the thickness of the cover glass.

### Fourth Example

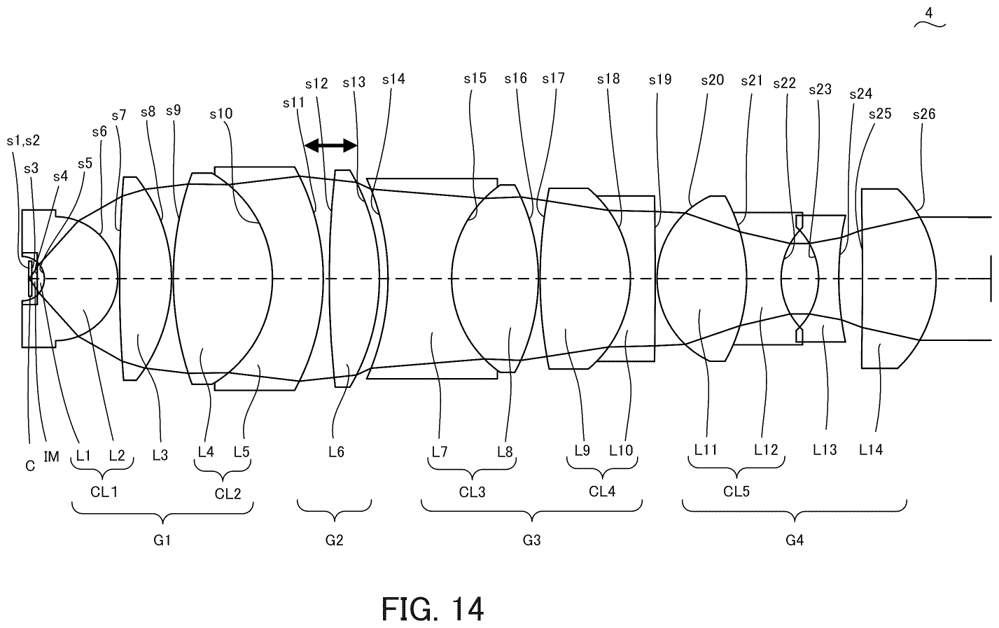

FIG. 14 is a cross-sectional view of an objective 4 according to the present example. The objective 4 is a liquid immersion objective for microscope. The objective 4 includes, in order from the object side, a first lens group G1 having positive refractive power, a second lens group G2 having positive refractive power, and a third lens group G3, and a fourth lens group G4.

The first lens group G1 includes, in order from the object side, a cemented lens CL1, a lens L3 that is a biconvex lens, and a cemented lens CL2. The cemented lens CL1 is a two-lens cemented lens in which a lens L1 that is a positive lens having a convex surface directed to the image side and a lens L2 that is a meniscus lens having a concave surface directed to the object side are cemented, and is a first lens component. The cemented lens CL2 is a two-lens cemented lens in which a lens L4 that is a biconvex lens and a lens L5 that is a meniscus lens having a concave surface directed to the object side are cemented. Both the cemented lens CL1 and the cemented lens CL2 are not cemented lenses in which the negative lens is disposed closer to the object side than the positive lens.

The second lens group G2 includes a lens L6 that moves along the optical axis. The lens L6 is a biconvex lens and is a single lens.

The third lens group G3 includes, in order from the object side, a cemented lens CL3 and a cemented lens CL4. The cemented lens CL3 is a two-lens cemented lens in which a lens L7 that is a biconcave lens and a lens L8 that is a biconvex lens are cemented. The cemented lens CL4 is a two-lens cemented lens in which a lens L9 that is a biconvex lens and a lens L10 that is a meniscus lens having a concave surface directed to the object side are cemented. The cemented lens CL3 has a cemented surface with a concave surface directed to the image side, and the cemented lens CL4 has a cemented surface with a concave surface directed to the object side.

The fourth lens group G4 includes, in order from the object side, a cemented lens CL5, a lens L13 that is a biconcave lens, and a lens L14 that is a meniscus lens having a concave surface directed to the object side. The cemented lens CL5 is a two-lens cemented lens in which a lens L11 that is a biconvex lens and a lens L12 that is a biconcave lens are cemented.

Various types of data of the objective 4 are as follows.

$$NA = 1.12 , f = 3.0 \; 02 mm , {f}_{G 1} = 4.31 mm , {f}_{G 2} = 22.205 mm , {f}_{G 3} = - 19.463 mm , {f}_{G 4} = - 54.391 mm , T T L = 49.5 \; 61 mm , {d}_{1 GR} = 16.092 mm , {d}_{3 G F} = 19.624 mm , {d}_{F B} = 29.765 mm$$

Lens data of the objective 4 is as follows.

Objective Lens 4

| s | r | d | nd | νd |
|---|---|---|---|---|
| 1 | INF | 0 | 1.33304 | 55.79 |
| 2 | INF | t | 1.52397 | 54.41 |
| 3 | INF | D0 | 1.33304 | 55.79 |
| 4 | INF | 0.395 | 1.45858 | 67.84 |
| 5 | −1.2180 | 4.001 | 1.80400 | 46.53 |
| 6 | −3.3879 | 0.100 | | |
| 7 | 69.7154 | 2.836 | 1.56907 | 71.30 |
| 8 | −8.9959 | 0.100 | | |
| 9 | 16.7994 | 5.419 | 1.43875 | 94.66 |
| 10 | −6.7030 | 2.773 | 1.63775 | 42.41 |
| 11 | −12.6961 | D1 | | |
| 12 | 53.8449 | 2.743 | 1.43875 | 94.66 |
| 13 | −11.7097 | D2 | | |
| 14 | −13.4266 | 3.474 | 1.63775 | 42.41 |
| 15 | 6.2754 | 4.738 | 1.43875 | 94.66 |
| 16 | −10.8675 | 0.100 | | |
| 17 | 25.2227 | 4.930 | 1.43875 | 94.66 |
| 18 | −6.4493 | 1.350 | 1.67790 | 55.35 |
| 19 | −313.6822 | 0.100 | | |
| 20 | 4.9709 | 4.898 | 1.49700 | 81.54 |
| 21 | −9.2306 | 1.881 | 1.75500 | 52.32 |
| 22 | 3.9528 | 2.048 | 1.00000 | |
| 23 | −3.9088 | 1.100 | 1.51823 | 58.90 |
| 24 | 16.5633 | 1.296 | 1.00000 | |
| 25 | −170.3558 | 4.020 | 1.67300 | 38.26 |
| 26 | −6.7821 | 110.000 | | |

D0, D1, and D2, which are values (unit: mm) of the intervals d3, d11, and d13 in the lens data in each of the first state to the third state, are as follows.

First State, Second State, and Third State

| | | | |
|---|---|---|---|
| t | 0.17 | 0.11 | 0.23 |
| D0 | 0.298 | 0.337 | 0.259 |
| D1 | 0.325 | 0.372 | 0.276 |
| D2 | 0.465 | 0.418 | 0.514 |

The objective 4 satisfies conditional expressions (1) and (2) as indicated below.

$$\vert {d}_{1 GR} / TTL \vert = 0.32 \qquad ( 1 )$$

$$\vert {d}_{3 G F} / {d}_{F B} \vert = 0.66 \qquad ( 2 )$$

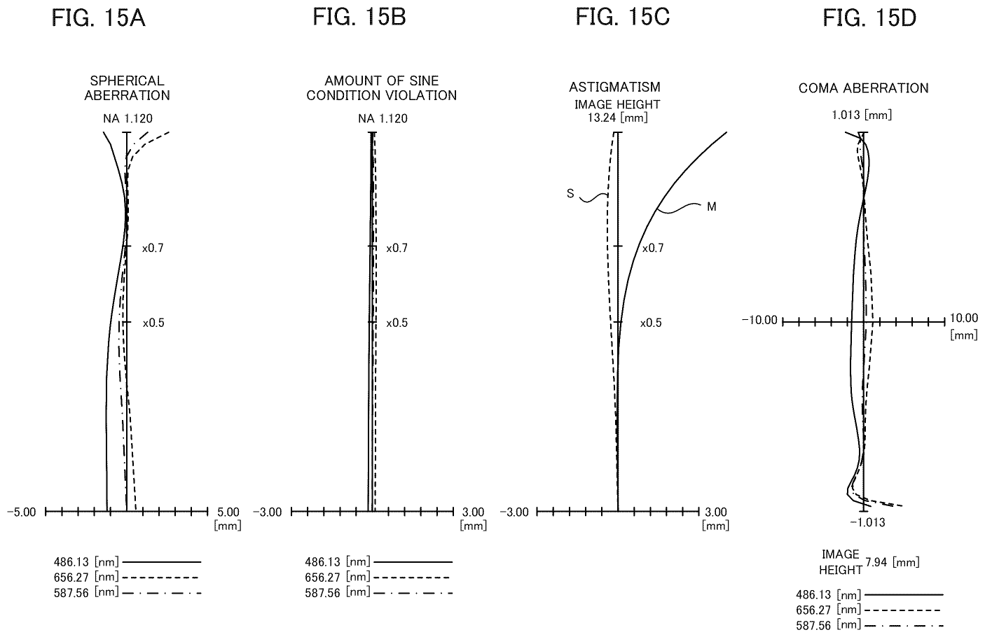

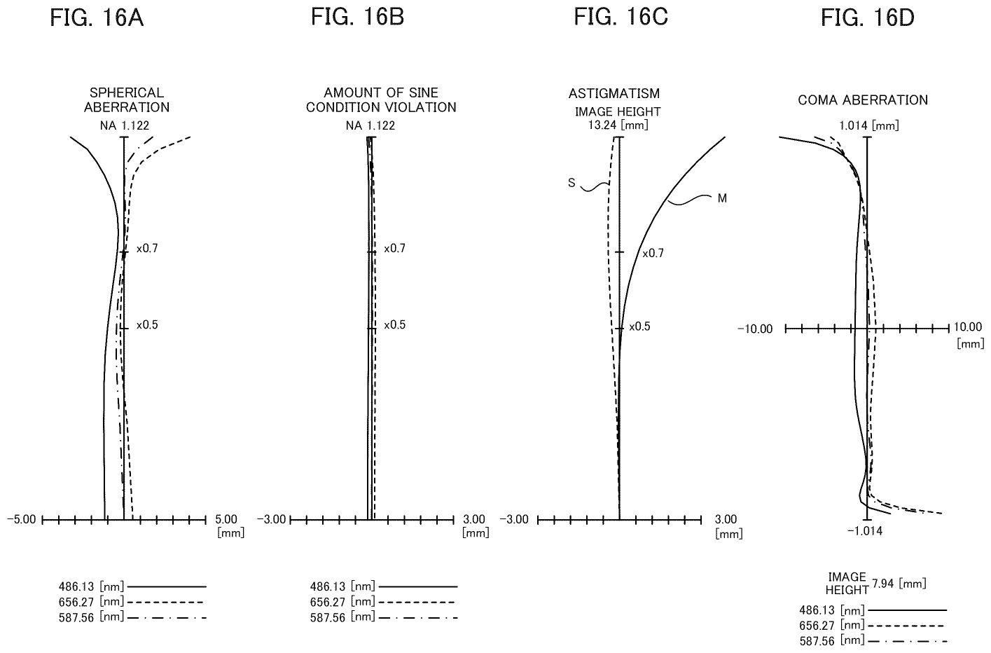

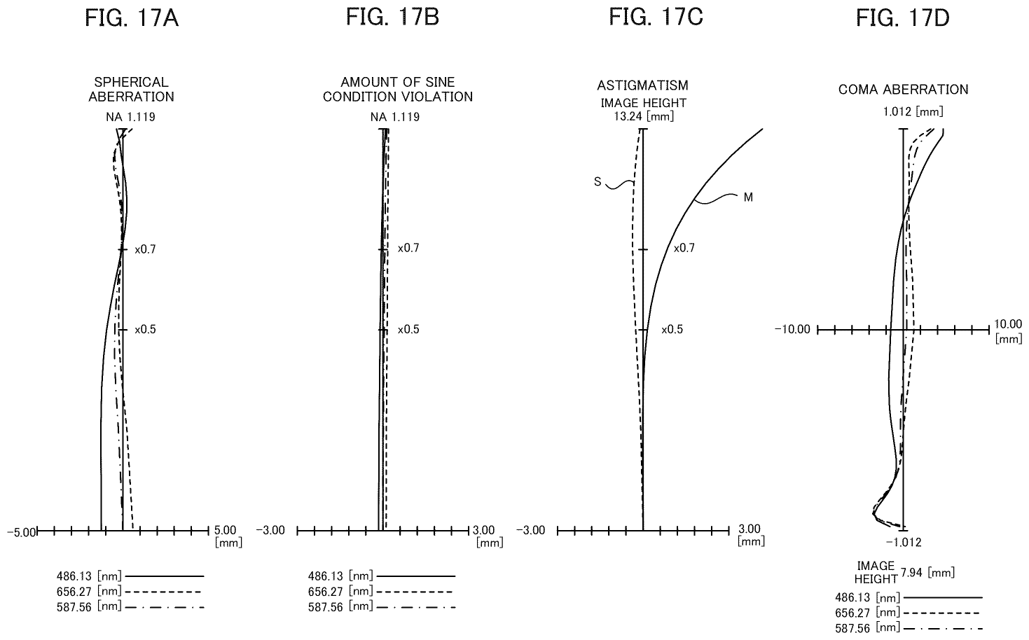

FIGS. 15A to 17D are aberration diagrams of the optical system including the objective 4 and the imaging lens 10, and illustrate aberrations on an image plane on which the objective 4 and the imaging lens 10 are formed, in the first state, the second state, and the third state, respectively. FIGS. 15A, 16A, and 17A are diagrams of spherical aberrations. FIGS. 15B, 16B, and 17B are diagrams illustrating the amounts of sine condition violation. FIGS. 15C, 16C, and 17C are astigmatism diagrams. FIGS. 15D, 16D, and 17D are diagrams illustrating coma aberrations at an image height ratio of 0.6 (image height of 7.95 mm). As illustrated in FIGS. 15A to 17D, in the present example, the aberration is favorably corrected regardless of the thickness of the cover glass.

The embodiment described above are illustrative examples shown to facilitate understanding of the invention. The present invention is not limited to the above-described embodiment, and should be understood as including various modifications and alternative forms of the above-described embodiment. For example, it will be understood that the above-described embodiment can be embodied by modifying components without departing from the spirit thereof. In addition, it will be understood that various embodiments can be implemented by appropriately combining a plurality of components disclosed in the above-described embodiment. Furthermore, a person skilled in the art may understand that various embodiments may be implemented by removing some components from all the components described in the embodiments or adding some components to the components described in the embodiments.

What is claimed is:

1. An objective comprising:
in order from an object side,
a first lens group having positive refractive power;
a second lens group having positive refractive power and configured to move along an optical axis;
a third lens group having two or more cemented surfaces; and
a fourth lens group including, in order from the object side, a lens having a convex surface directed to the object side, a lens having a concave surface directed to an image side, a lens having a concave surface directed to the object side, and a lens having a convex surface directed to the image side,
wherein the first lens group
has at least three or more lens components including a first lens component in which a positive lens having a convex surface directed to the image side and a meniscus lens having a concave surface directed to the object side are cemented, on an outermost object side, and
none of the at least three or more lens components is a cemented lens in which a negative lens is disposed closer to the object side than a positive lens.

2. The objective according to claim 1,
wherein the third lens group includes two cemented lens components.

3. The objective according to claim 2,
wherein each of the two cemented lens components has a cemented surface with a concave surface directed to the image side.

4. The objective according to claim 1,
wherein the fourth lens group includes three or more lens components.

5. The objective according to claim 1,
wherein the second lens group consists of one lens component having a meniscus shape with a concave surface directed to the object side.

6. The objective according to claim 1,
wherein the second lens group consists of a single lens.

7. The objective according to claim 1,
wherein the first lens group has a cemented lens component in which a positive lens and a negative lens disposed in order from the object side are cemented, on the image side with respect to the first lens component.

8. The objective according to claim 1,
wherein a following conditional expression is satisfied,
$$0.25 ≦ \vert {d}_{1 GR} / TTL \vert ≦ 0.5 \qquad ( 1 )$$
where d_{1GR} is a distance on the optical axis from an object plane to a lens surface of the first lens group closest to the image side, and TTL is a distance on the optical axis from the object plane to a lens surface of the objective closest to the image side.

9. The objective according to claim 1,
wherein a following conditional expression is satisfied,
$$0.3 ≦ \vert {d}_{3 G F} / {d}_{F B} \vert ≦ 1 \qquad ( 2 )$$
where d_{3GF} is a distance on the optical axis from an object plane to a lens surface of the third lens group closest to the object side, and d_{FB} is a distance on the optical axis from the object plane to a rear focal position of the objective.

10. The objective according to claim 3,
wherein the fourth lens group includes three or more lens components.

11. The objective according to claim 3,
wherein the second lens group consists of one lens component having a meniscus shape with a concave surface directed to the object side.

12. The objective according to claim 3,
wherein the second lens group consists of a single lens.

13. The objective according to claim 3,
wherein the first lens group has a cemented lens component in which a positive lens and a negative lens disposed in order from the object side are cemented, on the image side with respect to the first lens component.

14. The objective according to claim 3,
wherein a following conditional expression is satisfied,
$$0.25 ≦ \vert {d}_{1 GR} / TTL \vert ≦ 0.5 \qquad ( 1 )$$
where d_{1GR} is a distance on the optical axis from an object plane to a lens surface of the first lens group closest to the image side, and TTL is a distance on the optical axis from the object plane to a lens surface of the objective closest to the image side.

15. The objective according to claim 3,
wherein a following conditional expression is satisfied,
$$0.3 ≦ \vert {d}_{3 G F} / {d}_{F B} \vert ≦ 1 \qquad ( 2 )$$
where d_{3GF} is a distance on the optical axis from an object plane to a lens surface of the third lens group closest to the object side, and d_{FB} is a distance on the optical axis from the object plane to a rear focal position of the objective.

16. The objective according to claim 4,
wherein the second lens group consists of one lens component having a meniscus shape with a concave surface directed to the object side.

17. The objective according to claim 4,
wherein the second lens group consists of a single lens.

18. The objective according to claim 4,
wherein the first lens group has a cemented lens component in which a positive lens and a negative lens disposed in order from the object side are cemented, on the image side with respect to the first lens component.

19. The objective according to claim 4,
wherein a following conditional expression is satisfied,
$$0.25 ≦ \vert {d}_{1 GR} / TTL \vert ≦ 0.5 \qquad ( 1 )$$
where d_{1GR} is a distance on the optical axis from an object plane to a lens surface of the first lens group closest to the image side, and TTL is a distance on the optical axis from the object plane to a lens surface of the objective closest to the image side.

20. The objective according to claim 4,
wherein a following conditional expression is satisfied.
$$0.3 ≦ \vert {d}_{3 G F} / {d}_{F B} \vert ≦ 1 \qquad ( 2 )$$
where d_{3GF} is a distance on the optical axis from an object plane to a lens surface of the third lens group closest to the object side, and der is a distance on the optical axis from the object plane to a rear focal position of the objective.
